(19) United States
(12) Patent Application Publication
(10) Pub. No.: US 2014/0169851 A1
(43) Pub. Date: Jun. 19, 2014

(54) LUBRICANT COATING DEVICE AND IMAGE FORMING APPARATUS

(71) Applicant: Konica Minolta, Inc., Tokyo (JP)

(72) Inventors: Hiroyuki SAITO, Tokyo (JP); Takashi AKAZAWA, Tokyo (JP); Kei OKAMURA, Kanagawa (JP); Eri YAGI, Kanagawa (JP)

(73) Assignee: Konica Minolta, Inc., Tokyo (JP)

(21) Appl. No.: 14/134,283

(22) Filed: Dec. 19, 2013

(30) Foreign Application Priority Data
Dec. 19, 2012 (JP) 2012-276762

(51) Int. Cl. G03G 21/00

(52) U.S. Cl. CPC G03G 21/0094
USPC 399/346

(57) ABSTRACT

A lubricant coating device includes a photoconductor and a leveling blade that levels a lubricant applied on a surface of the photoconductor, the leveling blade configured to abut the photoconductor in a trail direction with respect to a rotational direction of the photoconductor, wherein a hardness of a tip of the leveling blade, the tip being positioned on a side that abuts the surface of the photoconductor, is higher than hardness of a non-abutting portion that does not abut the surface of the photoconductor.

### CROSS REFERENCE TO RELATED APPLICATIONS

This application is entitled to and claims the benefit of Japanese Patent Application No. 2012-276762 filed on Dec. 19, 2012, the disclosure of which including the specification, drawings and abstract is incorporated herein by reference in its entirety.

### BACKGROUND OF THE INVENTION

1. Field of the Invention

The present invention relates to a lubricant coating device and an image forming apparatus.

2. Description of Related Art

Recent electrophotographic image forming apparatus include a lubricant coating device for coating photoconductor drums with lubricants (e.g., metal soap) having lubrication action to improve the cleaning performance on the photoconductor drum. Coating photoconductor drums with lubricants improves releasability of toner developed on the photoconductor drum (that is, reduces adhesion between the toner and the surface of the photoconductor drum), and improves transferability and thus image quality stability. Further, coating with lubricants reduces frictional resistance between the photoconductor drum and cleaning member (for example, a cleaning blade) thus prolonging the lifetime of the cleaning member. A configuration for defining a coating amount of lubricant is known that includes a leveling blade configured to level the lubricant applied on the photoconductor drum.

Japanese Patent Application Laid-Open No. 2010-152294 discloses a technique of preventing charging failure of a photoconductor due to contamination of a charging unit. In the technique disclosed in Japanese Patent Application Laid-Open No. 2010-152294, the charging unit is disposed across a minute gap from a photoconductor drum, and the charging polarity of substances (such as toner) adhered on the photoconductor drum after transfer is adjusted to be the same as the charging polarity with which the charging unit charges the photoconductor.

However, the lubricant coating device has a drawback that larger particles of lubricant applied on the photoconductor drum unwantedly slip through the leveling blade and enter the developing device, which causes charging failure of toner in the developing device and results in occurrence of image unevenness of the formed image or occurrence of scattering of toner due to the fact that less charged toner is conveyed and supplied on a developing roller. Further, when an image is developed after the lubricant enters into the developing device along with the toner, a blank spot image defect occurs in the formed image.

The above-described technique disclosed in Japanese Patent Application Laid-Open No. 2010-152294 is not directed to preventing occurrence of defects due to lubricants slipping through the leveling blade, and therefore does not include a configuration for preventing occurrence of such defects.

### SUMMARY OF THE INVENTION

An object of the present invention is to provide a lubricant coating device and an image forming apparatus which can prevent occurrence of defects due to a lubricant slipping through a leveling blade when a photoconductor is coated with the lubricant.

To achieve at least one of the above-mentioned objects, a lubricant coating device reflecting one aspect of the present invention includes a photoconductor and a leveling blade that levels a lubricant applied on a surface of the photoconductor, the leveling blade configured to abut the photoconductor in a trail direction with respect to a rotational direction of the photoconductor, wherein a hardness of a tip of the leveling blade, the tip being positioned on a side that abuts the surface of the photoconductor, is higher than hardness of a non-abutting portion that does not abut the surface of the photoconductor.

In the above-described lubricant coating device, it is preferable that the hardness of a material forming the tip is higher than the hardness of a material forming the non-abutting portion.

In the above-described lubricant coating device, it is preferable that surface hardening treatment is applied on the tip so that the hardness of the tip becomes higher than the hardness of the non-abutting portion.

In the above-described lubricant coating device, it is preferable that the leveling blade includes an abutting layer that abuts the surface of the photoconductor, and a support layer that supports the abutting layer, wherein the tip is included in the abutting layer, and the non-abutting portion is the support layer.

An image forming apparatus reflecting other aspects of the present invention includes the above-described lubricant coating device.

### BRIEF DESCRIPTION OF DRAWINGS

The present invention will become more fully understood from the detailed description given hereinbelow and the appended drawings which are given by way of illustration only, and thus are not intended as a definition of the limits of the present invention, and wherein:

FIG. 1 is a longitudinal cross-sectional view of an image forming apparatus according to an embodiment of the present invention;

FIG. 2 is a control block diagram of the image forming apparatus according to the embodiment of the present invention;

FIG. 3 illustrates a configuration of a lubricant coating device according to the embodiment of the present invention;

FIG. 4 illustrates how a lubricant is evenly fixed on a surface of a photoconductor drum;

FIG. 5 illustrates relationship between an abutting force and an abutting angle of the leveling blade and phenomena occurring when the lubricant passes through an abutting portion of the leveling blade;

FIGS. 6A and 6B illustrate how the lubricant slips through the abutting portion of the leveling blade;

FIGS. 7A and 7B are illustrations for explaining an inroad amount and an effective abutting angle of the leveling blade;

FIG. 8 illustrates a modified example of a configuration of the leveling blade;

FIG. 9 illustrates another modified example of the configuration of the leveling blade;

FIG. 10 is a table showing results of the experiments of Example 1 and Comparative Example 1;

FIG. 11 is a table showing results of the experiments of Example 2 and Comparative Example 2; and

FIG. 12 is a table showing results of the experiments of Example 3 and Comparative Example 3.

### DESCRIPTION OF THE PREFERRED EMBODIMENTS

An embodiment of the present invention will be described in detail below with reference to the accompanying drawings.

### [Configuration of Image Forming Apparatus 100]

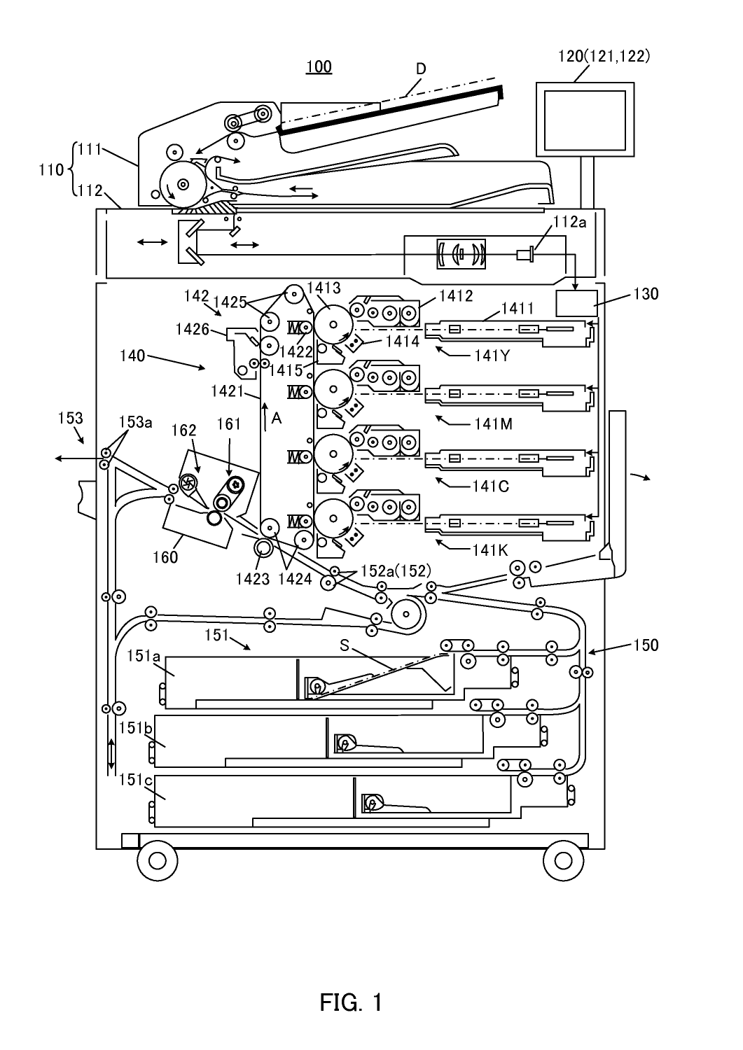

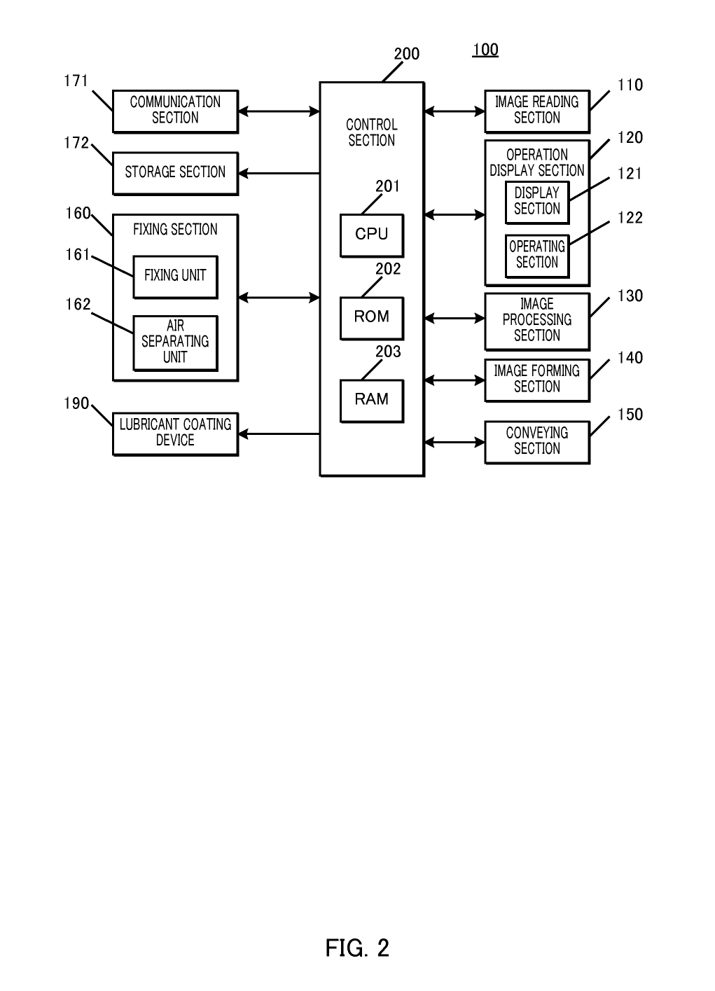

Image forming apparatus 100 shown in FIGS. 1 and 2 is an intermediate transfer type color image forming apparatus utilizing an electrophotographic process technique. Image forming apparatus 100 forms an image through primary transfer in which toner images of C (Cyan), M (Magenta), Y (Yellow) and K (black) formed on photoconductors are transferred on an intermediate transfer member and through secondary transfer in which toner images of the four colors are transferred on a recording sheet after being superimposed on the intermediate transfer member.

Image forming apparatus 100 is a tandem image forming apparatus in which photoconductors corresponding to four colors of CMYK are arranged in series in a miming direction of the intermediate transfer member and toner images of the respective colors are sequentially transferred on the intermediate transfer member in a single step.

Image forming apparatus 100 includes image reading section 110, operation display section 120, image processing section 130, image forming section 140, conveying section 150, fixing section 160, lubricant coating device 190 and control section 200.

Control section 200 includes CPU (Central Processing Unit) 201, ROM (Read Only Memory) 202, RAM (Random Access Memory) 203, or the like. CPU 201 reads a program corresponding to processing from ROM 202, deploys the program in RAM 203 and performs centralized control on operation of blocks of image forming apparatus 100 in cooperation with the deployed program while referring to various data stored in storage section 172. Storage section 172 is made up of, for example, a non-volatile semiconductor memory (so-called, flash memory) or a hard disk drive.

Control section 200 performs transmission and reception of various data with an external apparatus (for example, personal computer) connected to a communication network such as LAN (Local Area Network) or WAN (Wide Area Network) through communication section 171. For example, control section 200 receives image data transmitted from the external apparatus and forms an image on a recording sheet based on this image data (input image data). Communication section 171 is made up of, for example, a communication control card such as a LAN card.

Image reading section 110 includes automatic document feeding apparatus 111 referred to as an ADF (Auto Document Feeder), original image scanning apparatus (scanner) 112, or the like.

Automatic document feeding apparatus 111 conveys original document D placed on an original document tray to original image scanning apparatus 112 using a conveying mechanism.

Automatic document feeding apparatus 111 is capable of successively reading images (including on both sides) of original document D placed on the original document tray.

Original image scanning apparatus 112 reads an original image by optically scanning original document D conveyed onto a contact glass from automatic document feeding apparatus 111 or original document D placed on the contact glass and forming an image of a reflected light from original document D on a light receiving face of CCD (Charge Coupled Device) sensor 112a. Image reading section 110 generates input image data based on the result read by original image scanning apparatus 112. Image processing section 130 performs predetermined image processing on this input image data.

Operation display section 120, which is made up of, for example, a liquid crystal display (LCD: Liquid Crystal Display) with a touch panel, functions as display section 121 and operating section 122. Display section 121 displays various operation screens, a state of an image, an operation state of each function, or the like according to a display control signal input from control section 200. Operating section 122, which includes various operation keys such as a numerical keypad and a start key, receives various input operation by a user and outputs an operation signal to control section 200.

Image processing section 130 includes a circuit, or the like for performing digital image processing according to initial setting or user setting on the input image data. For example, image processing section 130 corrects tone based on tone correction data (tone correction table) under the control of control section 200. Image processing section 130 also performs various correction processing such as color correction and shading correction in addition to tone correction, compression processing, or the like on the input image data. Image forming section 140 is controlled based on the image data to which these processing has been applied.

Image forming section 140 includes image forming units 141Y, 141M, 141C and 141K for forming images using color toners of a Y component, an M component, a C component and a K component based on the input image data, intermediate transfer unit 142, and the like.

Image forming units 141Y, 141M, 141C and 141K for the Y component, the M component, the C component and the K component have the same configuration. For convenience of illustration and explanation, components common in these units are illustrated with the same reference numerals, and when it is necessary to distinguish between them, Y, M, C or K is added to the reference numerals. In FIG. 1, reference numerals are only assigned to components of image forming unit 141Y for the Y component, and reference numerals for components of image forming units 141M, 141C and 141K are omitted.

A configuration of image forming unit 141 will be described using image forming unit 141Y Image forming unit 141Y includes exposing device 1411, developing device 1412, photoconductor drum 1413, charging device 1414, drum cleaning device 1415, and the like.

Photoconductor drum 1413 is, for example, a negative charge type organic photoconductor (OPC: Organic Photo-conductor) in which an under coat layer (UCL: Under Coat layer), a charge generation layer (CGL: Charge Generation Layer), a charge transport layer (CTL: Charge Transport Layer) and an over coat layer (OCL: Over Coat Layer) are sequentially laminated on the circumferential surface of a conductive cylindrical body made of aluminum (aluminum tube).

Charging device 1414 uniformly and negatively charges a surface of photoconductor drum 1413. Exposing device 1411, which is made up of, for example, a semiconductor laser, radiates a laser light corresponding to an image of each color component to photoconductor drum 1413. Positive charge is generated at the charge generation layer of photoconductor drum 1413 and transported to a surface of the charge transport layer, thereby surface charge (negative charge) of photoconductor drum 1413 is neutralized. An electrostatic latent image of each color component is formed on the surface of photoconductor drum 1413 by a potential difference with the surroundings.

Developing device 1412, which stores a developer of each color component (for example, a two-component developer formed of a toner with a small particle size and a magnetic material (carrier)), forms a toner image by attaching toner of each color component to the surface of photoconductor drum 1413 to thereby visualize the electrostatic latent image.

Drum cleaning device 1415 has a drum cleaning blade which is in sliding contact with the surface of photoconductor drum 1413. The residual toner remaining on the surface of photoconductor drum 1413 after primary transfer is scraped off and removed by the drum cleaning blade.

Intermediate transfer unit 142 includes intermediate transfer belt 1421 which is an intermediate transfer member, primary transfer roller 1422, secondary transfer roller 1423, drive roller 1424, driven roller 1425, belt cleaning device 1426, and the like.

Intermediate transfer belt 1421, which is formed into an endless belt, hangs over drive roller 1424 and driven roller 1425. Intermediate transfer belt 1421 runs in a direction of arrow A at a constant speed by rotation of drive roller 1424. When intermediate transfer belt 1421 is pressed against photoconductor drum 1413 by primary transfer roller 1422, toner images of respective colors are primarily transferred on intermediate transfer belt 1421 while being sequentially superimposed. When intermediate transfer belt 1421 is pressed against recording sheet S by secondary transfer roller 1423, the toner image primarily transferred on intermediate transfer belt 1421 is secondary transferred on recording sheet S.

Belt cleaning device 1426 has a belt cleaning blade which is in sliding contact with a surface of intermediate transfer belt 1421. The residual toner remaining on the surface of intermediate transfer belt 1421 after secondary transfer is scraped off and removed by the belt cleaning blade.

Fixing section 160 fixes the toner image on recording sheet S by applying heat and pressure on conveyed recording sheet S at a fixing nip portion. Fixing section 160 includes fixing unit 161 and air separating unit 162. Fixing unit 161 fixes the toner image on recording sheet S by making recording sheet S pass through the fixing nip portion formed by a pair of fixing members being pressed and providing heat from a heat source to the toner image transferred on recording sheet S. Air separating unit 162 separates recording sheet S from the fixing member by outputting compressed air to recording sheet S from an ejecting side of recording sheet S at the fixing nip portion.

Conveying section 150 includes sheet feeding section 151, conveying mechanism 152, sheet ejecting section 153, and the like. Recording sheets (standard paper, special paper) S identified based on basis weight, size or the like of the recording sheets are stored in three sheet feed tray units 151a to 151c constituting sheet feeding section 151 for each predetermined type.

Recording sheets S stored in sheet feed tray units 151a to 151c are sent out one by one from an uppermost sheet and conveyed to image forming section 140 by conveying mechanism 152 provided with a plurality of conveyance rollers such as registration roller 152a. At this time, a registration section in which registration roller 152a is arranged corrects skew of fed recording sheet S and adjusts a conveying timing. Image forming section 140 performs secondary transfer of the toner image on intermediate transfer belt 1421 onto one side of recording sheet S at one time and fixing section 160 performs fixing process. Recording sheet S on which an image is formed is ejected out of image forming apparatus 100 by sheet ejecting section 153 provided with sheet discharging roller 153a.

[Configuration of Lubricant Coating Device 190]

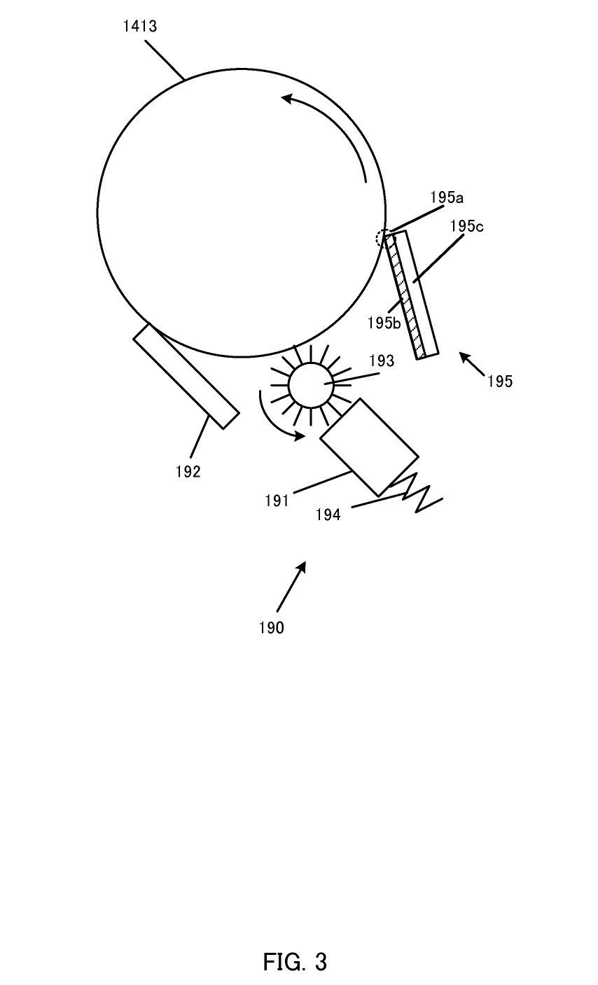

In the present embodiment, as shown in FIG. 3, lubricant coating device 190 which coats photoconductor drum 1413 with solid lubricant 191 is provided at a downstream side of drum cleaning blade 192 with respect to a rotational direction of photoconductor drum 1413.

Lubricant coating device 190 includes lubricant 191, coating brush 193, pressing spring 194 and leveling blade 195. Lubricant coating device 190 is provided at each of image forming units 141Y, 141M, 141C and 141K.

Coating brush 193 is, for example, made up of a base cloth having a thickness of 0.5 [mm] on which a bundle of acrylic fiber is woven and implanted in a loop shape to have a height of 2.5 [mm] wound around a metal shaft having an outer diameter of 14 [mm]. Coating brush 193 is positioned so as to be pushed back by photoconductor drum 1413 by approximately 1.0 [mm]. Coating brush 193 rotates in the same direction as the rotational direction of photoconductor drum 1413 at, for example, 400 [mm/second]. Coating brush 193 is rotationally driven by a control signal from control section 200.

Lubricant 191 is formed by solidifying and shaping a lubricant such as zinc stearate (ZnSt) corresponding to pencil hardness of HB. Lubricant 191 is formed to have the same length in a depth direction in the drawing as the axial length of photoconductor drum 1413, and is pressed in a direction of coating brush 193 by pressing spring 194. A right end of pressing spring 194 in the drawing is fixed by a housing (not shown). Further, a plurality of pressing springs 194 are arranged in an axial direction of coating brush 193 in a balanced manner.

Coating brush 193 scrapes off lubricant 191 with hair of rotating coating brush 193 and coats the surface of photoconductor drum 1413 with fine powders (particles of approximately 2 to 10 [μm]) of scraped lubricant 191. Leveling blade 195 has a free end having a length of 6 [mm], and is provided at a downstream side of coating brush 193 with respect to the rotational direction of photoconductor drum 1413. One end of leveling blade 195 abuts photoconductor drum 1413 such that the orientation of leveling blade 195 is in line with the rotational direction of photoconductor drum 1413 (i.e., trail direction) and that leveling blade 195 maintains a constant angle with respect to the surface of photoconductor drum 1413. The other end of leveling blade 195 is supported by a blade folder (not shown). Leveling blade 195 evenly fixes lubricant 191 applied on the surface of photoconductor drum 1413 by coating brush 193.

In order to evenly fix lubricant 191 applied on the surface of photoconductor drum 1413, it is necessary to apply a sufficient load on leveling blade 195. However, if the load is large, internal stress of leveling blade 195 is increased, which causes a creep phenomenon in which leveling blade 195 is deflected over time. When the creep phenomenon occurs, an abutting force of leveling blade 195 with respect to the surface of photoconductor drum 1413 cannot be sufficiently ensured, which causes a problem of lubricant 191 with a large particle size applied on photoconductor drum 1413 passing through leveling blade 195 and entering into developing device 1412. Hereinafter, a state where “lubricant 191 with a large particle size passes through leveling blade 195” will be referred to as “lubricant 191 slips through leveling blade 195”.

When lubricant 191 slips through leveling blade 195, toner charging failure occurs inside developing device 1412, which causes image unevenness in the formed image or scattering of toner due to low charged toner being conveyed and supplied on the developing roller. Further, when an image is developed after lubricant 191 enters into developing device 1412 along with toner, a blank spot image defect occurs in the formed image.

In order to prevent occurrence of the above-described creep phenomenon, one possible measure is to form leveling blade 195 with an elastic member with a low modulus of repulsion elasticity. However, in the case of leveling blade 195 formed of the elastic member with a low modulus of repulsion elasticity, leveling blade 195 has low hardness, and leveling blade 195 largely deforms when sufficient load is applied to leveling blade 195. Large deformation of leveling blade 195 makes an abutting angle of leveling blade 195 with respect to the surface of photoconductor drum 1413 small and increases an area where the abutting portion contacts photoconductor drum 1413, which results in the reduction in a peak pressure occurring at the abutting portion of leveling blade 195 with respect to the surface of photoconductor drum 1413 and allowing lubricant 191 to slip through leveling blade 195.

Accordingly, as shown in FIG. 3, in the present embodiment, leveling blade 195 has a structure in which abutting layer 195b including abutting portion 195a which abuts the surface of photoconductor drum 1413, and support layer 195c that supports abutting layer 195b are laminated. The thickness of abutting layer 195b is 0.6 [mm], and the thickness of support layer 195c is 1.4 [mm], that is, the total thickness of leveling blade 195 is 2.0 [mm]. Abutting layer 195b is formed of, for example, urethane rubber and has the hardness of 90. Support layer 195c is formed of, for example, urethane rubber and has the hardness of 79. The hardness of abutting layer 195b and support layer 195c is micro rubber hardness measured by ASKER MD-1 manufactured by Kobunshi Keiki Co. Ltd. Support layer 195c corresponds to the “non-abutting portion” of the present invention. It is also possible to use an elastic material such as silicon rubber besides urethane rubber to form abutting layer 195b.

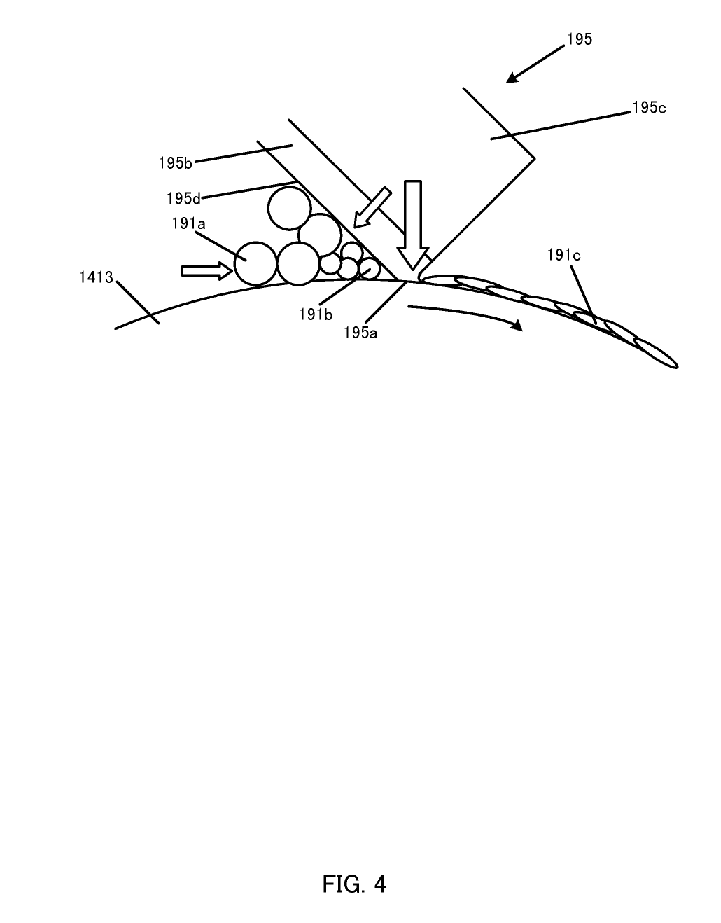

According to this configuration, as shown in FIG. 4, lubricant 191a (particles of approximately 2 to 10 [μm]) applied on the surface of photoconductor drum 1413 rolls by a kinetic friction force of friction with photoconductor drum 1413 occurring by rotation of photoconductor drum 1413 and is dammed by abutting face 195d located at the surface side of photoconductor drum 1413 in abutting layer 195b, and is fractured into fine pieces by being frictioned. Lubricant 191b which has been fractured into fine pieces is crushed by a peak pressure (pressing force) of a downward direction in the drawing occurring at abutting portion 195a while passing through abutting portion 195a of leveling blade 195. Crushed lubricant 191c is evenly fixed on the surface of photoconductor drum 1413. A portion of abutting face 195d where lubricant 191a is frictioned and abutting portion 195a correspond to the “tip” of the present invention.

When the hardness of abutting layer 195b is higher than the hardness of support layer 195c and a modulus of repulsion elasticity of abutting layer 195b is small, a creep phenomenon may occur at leveling blade 195. However, by forming support layer 195c with a low repulsion member having a low modulus of repulsion elasticity, it is possible to prevent occurrence of a creep phenomenon. Accordingly, an abutting angle of leveling blade 195 with respect to the surface of photoconductor drum 1413 becomes small, and an area where the surface of photoconductor drum 1413 contacts abutting portion 195a will not increase, so that it is possible to sufficiently ensure a peak pressure (for example, 0.5 [N/m²]) occurring at abutting portion 195a of leveling blade 195 with respect to the surface of photoconductor drum 1413. Further, as the occurrence of a creep phenomenon can be prevented, it is possible to reduce fatigue accumulated on leveling blade 195 and provide longer life of leveling blade 195.

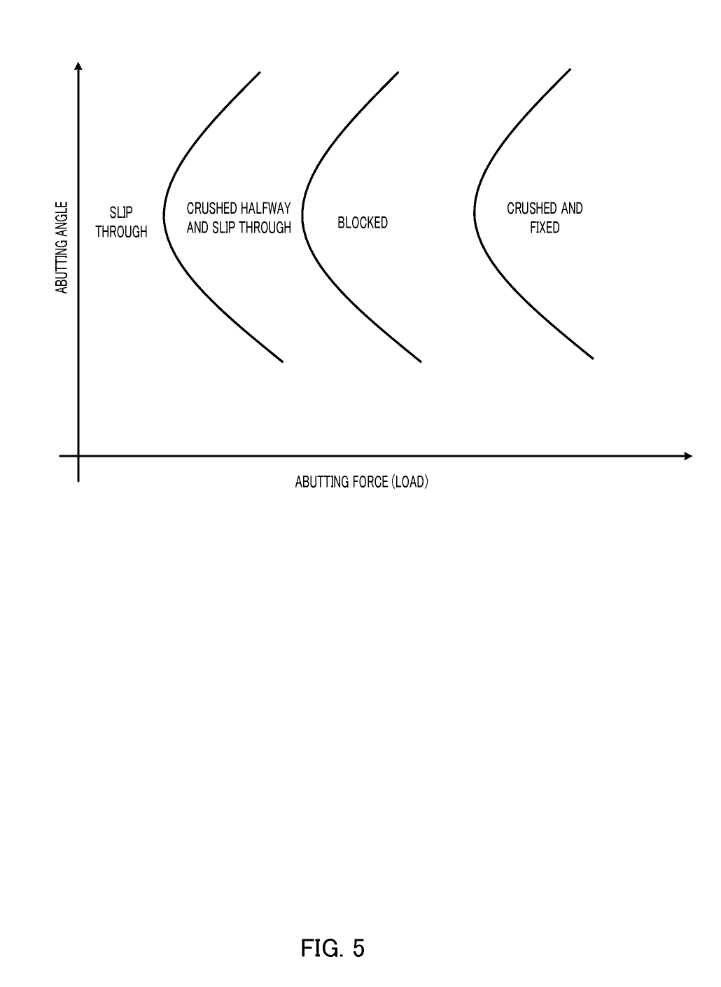

As shown in FIG. 5, according to a load (abutting force) to be applied to leveling blade 195 and a way of setting the abutting angle of leveling blade 195 with respect to the surface of photoconductor drum 1413, different phenomena occur when lubricant 191 passes through abutting portion 195a of leveling blade 195. That is, when the abutting force is small, lubricant 191 applied on the surface of photoconductor drum 1413 cannot be sufficiently leveled, lubricant 191 with a large particle size will slip through leveling blade 195. When the abutting force is slightly larger, while it is possible to prevent lubricant 191 with a large particle size from slipping through leveling blade 195, lubricant 191 with a medium particle size which has been crushed halfway slips through leveling blade 195. When the abutting force is made further larger, while it is possible to crush lubricant 191 into finer pieces and prevent lubricant 191 with a medium particle size from slipping through leveling blade 195, lubricant 191 cannot be sufficiently fixed on the surface of photoconductor drum 1413 because a large load is applied to the photoconductor to drive, which causes defects such as uneven rotation. By setting an appropriate abutting angle as well as a sufficient abutting force, it is possible to crush lubricant 191 into small pieces and sufficiently fix lubricant 191 on the surface of photoconductor drum 1413. If the abutting angle is not appropriate though a sufficient abutting force is applied (that is, when the abutting angle is too large or too small), a peak pressure occurring at abutting portion 195a cannot be sufficiently ensured, which makes it easy for lubricant 191 to slip through leveling blade 195.

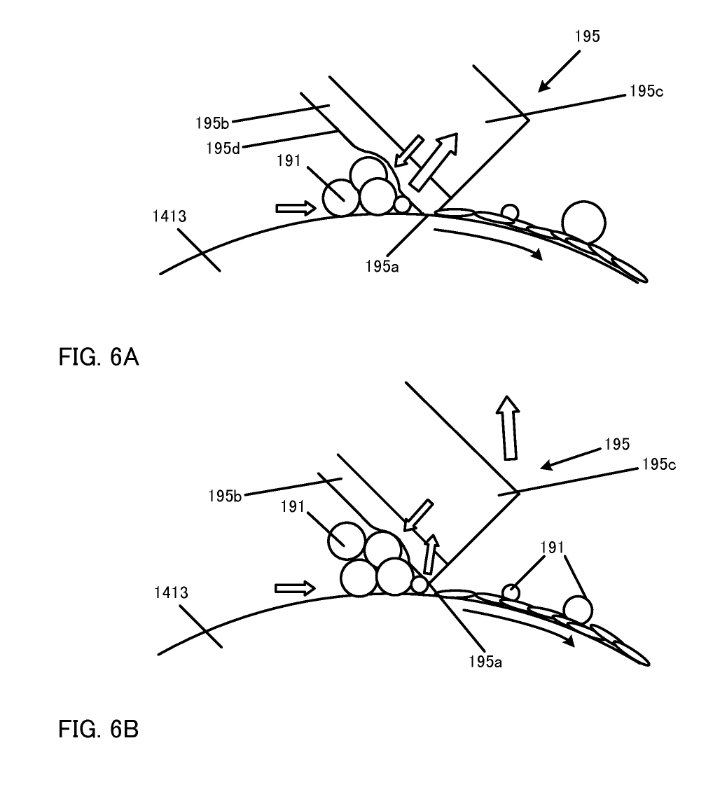

When the hardness of abutting layer 195b is small, or the abutting force is small, or the effective abutting angle is small, as shown in FIG. 6A, lubricant 191 applied on the surface of photoconductor drum 1413 make inroads into abutting layer 195b of leveling blade 195, which results in, as shown in FIG. 6B, the reduction in the abutting force of leveling blade 195 with respect to the surface of photoconductor drum 1413 and making leveling blade 195 lifted in an upward direction in FIG. 6B. Accordingly, because the peak pressure occurring at abutting portion 195a cannot be sufficiently ensured, lubricant 191 is not sufficiently fixed on the surface of photoconductor drum 1413 and passes through leveling blade 195.

More specifically, when the hardness of abutting layer 195b is low or medium, lubricant 191 applied on the surface of photoconductor drum 1413 makes inroads into abutting layer 195b of leveling blade 195 and is accumulated. Accumulated lubricant 191 is pushed out by lubricant 191 which is subsequently applied on the surface of photoconductor drum 1413. As a result, lubricant 191 with a particle size of approximately 3 to 10 [μm] slips through leveling blade 195.

When the effective abutting angle is small, an area where the surface of photoconductor drum 1413 contacts abutting portion 195a is reduced, and a peak pressure occurring at abutting portion 195a cannot be sufficiently ensured. As a result, lubricant 191 with a particle size of approximately 3 to 10 [μm] slips through leveling blade 195.

The abutting force and the effective abutting angle will be described supplementarily. The abutting force is a force applied on the surface of photoconductor drum 1413 as a result of a load being applied on leveling blade 195 when leveling blade 195 is made to abut the surface of photoconductor drum 1413. The abutting force can be expressed by the following equation 1:

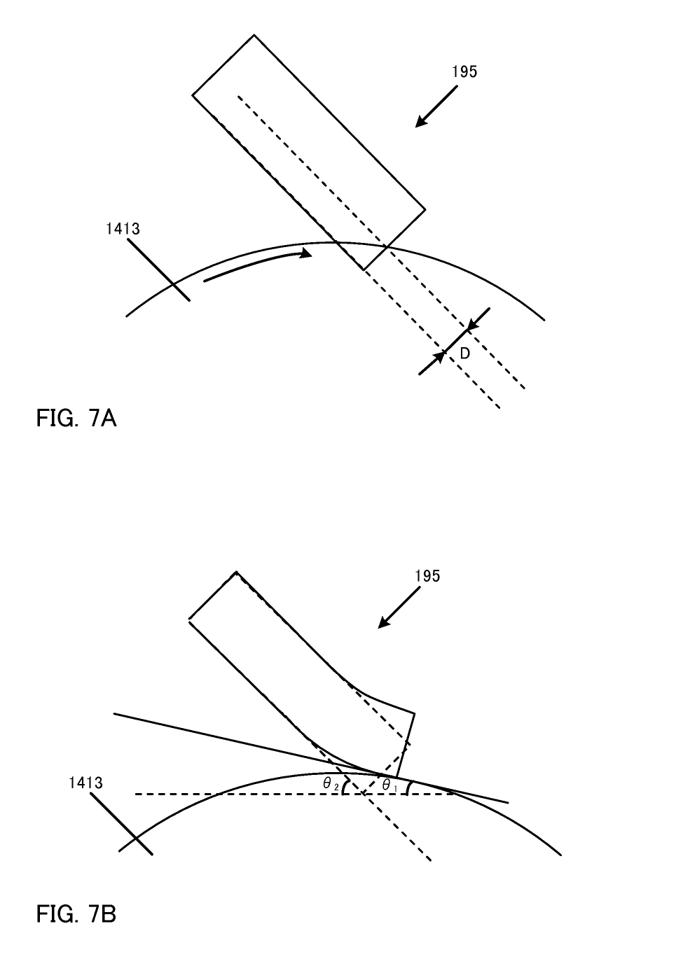

F=E·(d1+d2)³·D·1000/(4·L) (1)

where F is an abutting force, E is an average Young's modulus of leveling blade 195 expressed by the following equation 2, d1 is a thickness of abutting layer 195b, d2 is a thickness of support layer 195c, D is an inroad amount of leveling blade 195 with respect to photoconductor drum 1413, and L is a length of a free end of leveling blade 195. The “inroad amount D of leveling blade 195 with respect to photoconductor drum 1413” is defined as a maximum value obtained when a tip of leveling blade 195 inroads into an area where photoconductor drum 1413 is arranged assuming that there is no photoconductor drum 1413 as shown in FIG. 7A.

E=(d1·E1+d2·E2)/(d1+d2) (2)

where E1 is a Young's modulus of abutting layer 195b, and E2 is a Young's modulus of support layer 195c.

The effective abutting angle is, as shown in FIG. 7B, an actual angle (θ1) formed between the tip of leveling blade 195 (shown by a solid line) and the surface of photoconductor drum 1413. The effective abutting angle (θ1) can be obtained by calculating deflection using a cross-sectional shape of leveling blade 195 and a physical property value such as a Young's modulus of the material. An angle (θ2) shown in FIG. 7B is a rigid body abutting angle formed between the tip of leveling blade 195 and the surface of photoconductor drum 1413 when it is assumed that leveling blade 195 (shown by a dotted line) is a rigid body. The rigid body abutting angle (θ2) is a design value used when leveling blade 195 is made to abut the surface of photoconductor drum 1413.

As described in detail above, in the present embodiment, leveling blade 195 has a structure in which abutting layer 195b including abutting portion 195a which abuts the surface of photoconductor drum 1413 and support layer 195c supporting abutting layer 195b are laminated, and abutting layer 195b is formed of a material having higher hardness than a material forming support layer 195c.

According to the present embodiment configured as described above, it is possible to fracture lubricant 191 applied on the surface of photoconductor drum 1413 into fine pieces, and then reliably crush lubricant 191 which has been fractured into fine pieces by a peak pressure occurring at abutting portion 195a of leveling blade 195, so that it is possible to prevent lubricant 191 of coarse particles from slipping through leveling blade 195 and entering into developing device 1412 and thus prevent occurrence of defects (such as image unevenness, scattering of toner, and blank spot image defects) due to lubricant 191 slipping through leveling blade 195.

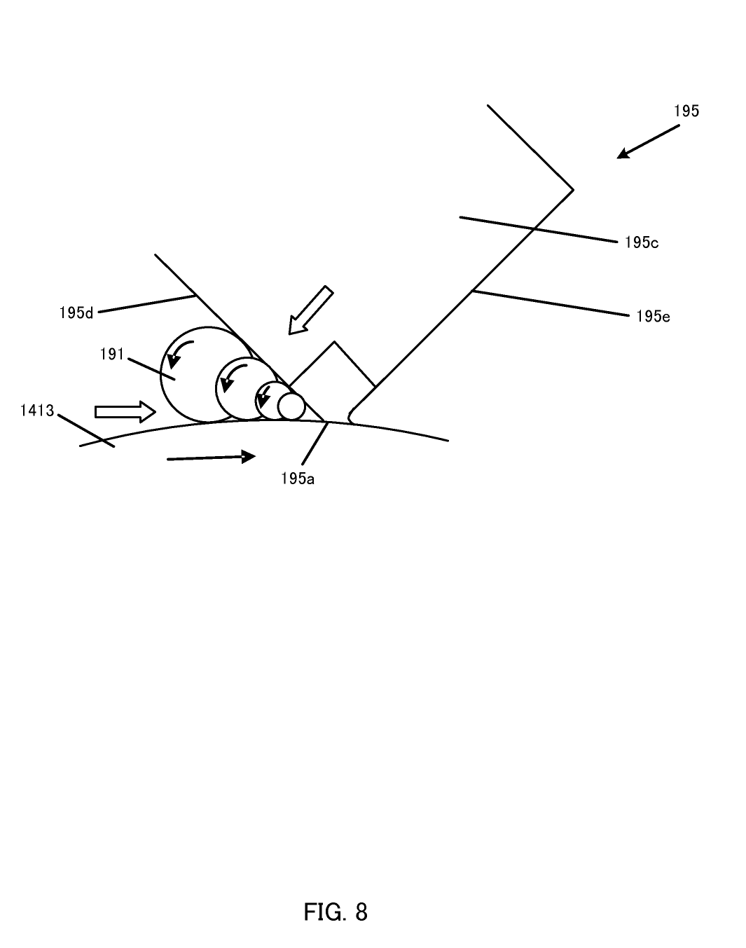

In the above-described embodiment, while an example has been described where abutting layer 195b of leveling blade 195 is formed of a material having higher hardness than a material forming support layer 195c in order to fracture lubricant 191 applied on the surface of photoconductor drum 1413 into fine pieces and reliably crush lubricant 191 by the peak pressure occurring at abutting portion 195a of leveling blade 195, the present invention is not limited thereto. For example, as shown in FIG. 8, it is also possible to configure leveling blade 195 in a single layer structure only including support layer 195c and apply hardening surface treatment to abutting face 195d at the side of photoconductor drum 1413 and cut face 195e of support layer 195c so that the hardness of abutting face 195d and cut face 195e is higher than the hardness of support layer 195c. In this case, a portion of abutting face 195d where lubricant 191a is frictioned to which the surface treatment has been applied, and abutting portion 195a correspond to the “tip” of the present invention. Further, support layer 195c corresponds to the “non-abutting portion” of the present invention. The surface treatment includes, for example, impregnation treatment or coating treatment using a urethane resin, treatment of applying a photocuring agent and radiating light for curing the photocuring agent (for giving a cross-linked structure).

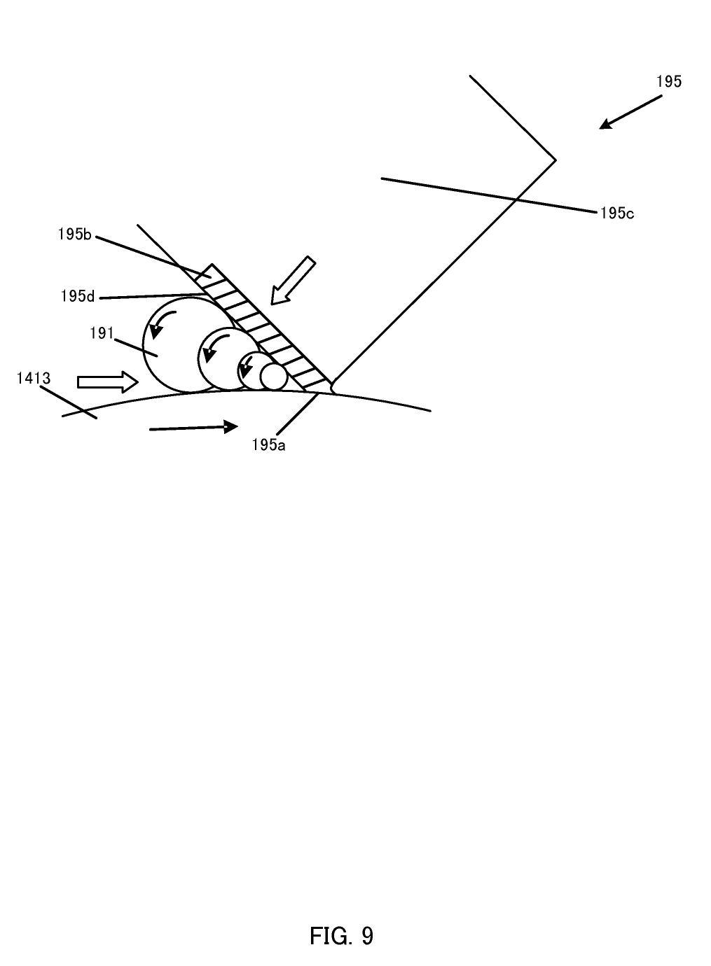

Further, as shown in FIG. 9, it is also possible to configure a portion of leveling blade 195 where lubricant 191a applied on the surface of photoconductor drum 1413 is frictioned and abutting portion 195a with abutting layer 195b and configure other portions with support layer 195c. In this case, abutting portion 195a corresponds to the “tip” of the present invention, and support layer 195c corresponds to the “non-abutting portion” of the present invention.

The above-described embodiment is merely one example of implementing the present invention, and the technical scope of the present invention should not be interpreted in a limited way by the above-described embodiment. That is, the present invention may be implemented in various forms without departing from the scope or main features of the present invention.

Lastly, results of experiments performed by the inventors of the present invention to confirm effectiveness in the above-described embodiment will be explained.

### CONFIGURATION OF LEVELING BLADE 195 ACCORDING TO EXAMPLE 1 AND COMPARATIVE EXAMPLE 1

Leveling blade 195 according to Example 1 has a structure in which abutting layer 195b including abutting portion 195a that abuts the surface of photoconductor drum 1413, and support layer 195c that supports abutting layer 195b are laminated. The thickness of abutting layer 195b is 0.6 [mm], and the thickness of support layer 195c is 1.4 [mm], that is, the total thickness of leveling blade 195 is 2.0 [mm]. The hardness of abutting layer 195b is 90, and the hardness of support layer 195c is 79. In contrast, leveling blade 195 according to Comparative Example 1 has a single layer structure only including support layer 195c. The thickness of support layer 195c, that is, the total thickness of leveling blade 195 is 2.0 [mm]. The hardness of support layer 195c is 72.

### CONFIGURATION OF LEVELING BLADE 195 ACCORDING TO EXAMPLE 2 AND COMPARATIVE EXAMPLE 2

Leveling blade 195 according to Example 2 has a single layer structure only including support layer 195c. Hardening surface treatment is applied to abutting face 195d of support layer 195c at the side of photoconductor drum 1413 so that the hardness of abutting face 195d becomes higher than the hardness of support layer 195c. This surface treatment is impregnation treatment using an epoxy resin or a urethane resin. The hardness of abutting face 195d is 88, and the harness of support layer 195c is 79. In contrast, leveling blade 195 according to Comparative Example 2 has a single layer structure only including support layer 195c. The thickness of support layer 195c, that is, the total thickness of leveling blade 195 is 2.0 [mm]. The hardness of support layer 195c is 70.

### CONFIGURATION OF LEVELING BLADE 195 ACCORDING TO EXAMPLE 3 AND COMPARATIVE EXAMPLE 3

Leveling blade 195 according to Example 3 has a single layer structure only including support layer 195c. Hardening surface treatment is applied to abutting face 195d of support layer 195c at the side of photoconductor drum 1413 so that the hardness of abutting face 195d becomes higher than the hardness of support layer 195c. This surface treatment is treatment of applying a photocuring agent and radiating light for curing the photocuring agent. The hardness of abutting face 195d is 76, and the hardness of support layer 195c is 70. In contrast, leveling blade 195 according to Comparative Example 3 has a single layer structure only including support layer 195c. The thickness of support layer 195c, that is the total thickness of leveling blade 195 is 2.0 [mm]. The hardness of support layer 195c is 70.

[Experimental Method]

Image forming processing was performed on 1,000 pages using leveling blades 195 according to Examples 1 to 3 and Comparative Examples 1 to 3, which were visually checked for the occurrence of blank spot image defects. The load (abutting force) applied on leveling blade 195 and the rigid body abutting angle of leveling blade 195 with respect to the surface of photoconductor drum 1413 were varied within a range of conditions in which leveling blade 195 is usually used.

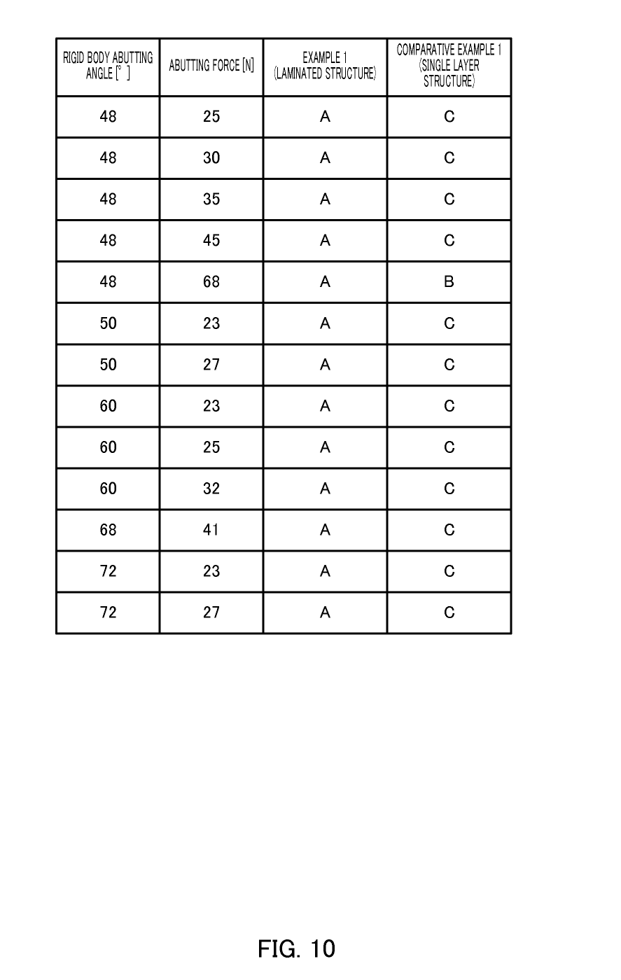

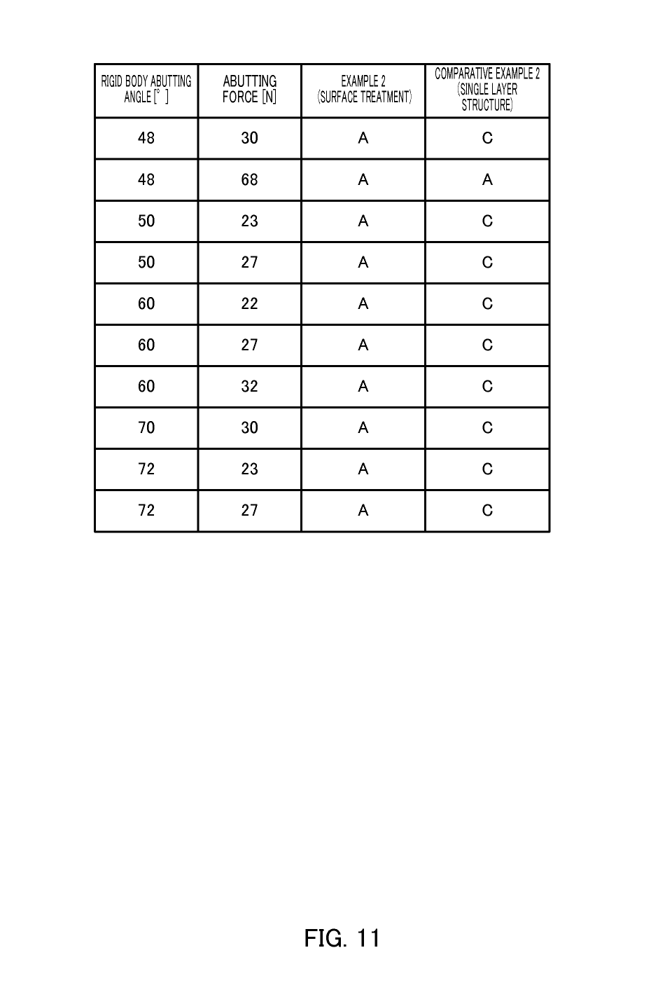

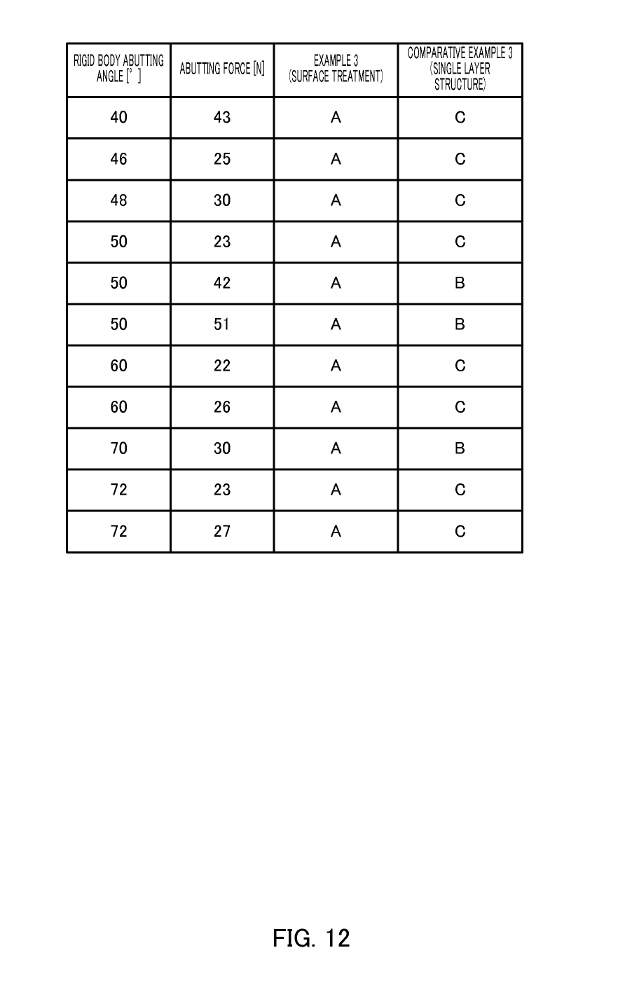

FIG. 10 illustrates results of evaluation of the occurrence of blank spot image defects conducted using the following evaluation criterion in a case where leveling blades 195 according to Example 1 and Comparative Example 1 were used. FIG. 11 illustrates results of evaluation of the occurrence of blank spot image defects conducted using the following evaluation criterion in a case where leveling blades 195 according to Example 2 and Comparative Example 2 were used. FIG. 12 illustrates results of evaluation of the occurrence of blank spot image defects conducted using the following evaluation criterion in a case where leveling blades 195 according to Example 3 and Comparative Example 3 were used.

(Occurrence of Blank Spot Image Defects)

A: Blank spot image defects did not occur in the formed image. Lubricant 191 could be crushed into fine pieces and sufficiently fixed on the surface of photoconductor drum 1413.

B: Blank spot image defects did not occur in the formed image, while lubricant 191 with a medium particle size which had been crushed halfway slipped through leveling blade 195.

C: Blank spot image defects occurred in the formed image. Lubricant 191 with a large particle size slipped through leveling blade 195.

As shown in FIG. 10, in Example 1, blank spot image defects did not occur in the formed image in all the conditions of the abutting force and the rigid body abutting angle. In contrast, in Comparative Example 1, while blank spot image defects did not occur, lubricant 191 with a medium particle size which had been crushed halfway slipped through leveling blade 195 when the abutting force and the rigid body abutting angle are respectively, 48[°] and 68 [N], and in other conditions, blank spot image defects occurred in the formed image. Thus, when leveling blade 195 is formed in a single layer structure, it can be considered that blank spot image defects occur because leveling blade 195 largely deforms, which increases an area where the abutting portion contacts photoconductor drum 1413 and reduces the peak pressure occurring at a portion where leveling blade 195 abuts the surface of photoconductor drum 1413.

As shown in FIG. 11, in Example 2, blank spot image defects did not occur in the formed image in all the conditions of the abutting force and the rigid body abutting angle. In contrast, in Comparative Example 2, while blank spot image defects did not occur when the abutting force and the rigid body abutting angle are respectively 48[°] and 68 [N], in other conditions, blank spot image defects occurred in the formed image.

As shown in FIG. 12, in Example 3, blank spot image defects did not occur in the formed image in all the conditions of the abutting force and the rigid body abutting angle. In contrast, in Comparative Example 3, while blank spot image defects did not occur when the abutting force and the rigid body abutting angle are respectively 50[°] and 42 [N], 50[°] and 51 [N], and 70[°] an 30 [N], lubricant 191 with a medium particle size which had been crushed halfway slipped through leveling blade 195. Further, in other conditions, blank spot image defects occurred in the formed image.

What is claimed is:

1. A lubricant coating device comprising:
a photoconductor; and
a leveling blade that levels a lubricant applied on a surface of the photoconductor, the leveling blade configured to abut the photoconductor in a trail direction with respect to a rotational direction of the photoconductor,
wherein a hardness of a tip of the leveling blade, the tip being positioned on a side that abuts the surface of the photoconductor, is higher than hardness of a non-abutting portion that does not abut the surface of the photoconductor.

2. The lubricant coating device according to claim 1, wherein a hardness of a material forming the tip is higher than a hardness of a material forming the non-abutting portion.

3. The lubricant coating device according to claim 1, wherein surface hardening treatment is applied to the tip so that the hardness of the tip becomes higher than the hardness of the non-abutting portion.

4. The lubricant coating device according to claim 1, wherein the leveling blade comprises:
an abutting layer that abuts the surface of the photoconductor; and
a support layer that supports the abutting layer,
wherein the tip is included in the abutting layer, and the non-abutting portion is the support layer.

5. An image forming apparatus comprising the lubricant coating device according to claim 1.
